(19) United States
(12) Patent Application Publication
(10) Pub. No.: US 2013/0045498 A1
(43) Pub. Date: Feb. 21, 2013

(54) VISCOSITY PRESSURE ASSAY

(71) Applicants: Gernot J. Abel, Copenhagen (DK); Dan Petterson, Lynge (DK)

(72) Inventors: Gernot J. Abel, Copenhagen (DK); Dan Petterson, Lynge (DK)

(73) Assignee: NOVOZYMES A/S, Bagsvaerd (DK)

(21) Appl. No.: 13/581,765

(22) PCT Filed: Mar. 1, 2011
(86) PCT No.: PCT/EP2011/053022

§ 371 Date: Nov. 8, 2012

(30) Foreign Application Priority Data
Mar. 1, 2010 (EP) 10154986.3

(51) Int. Cl. G01N 11/04

(52) U.S. Cl. 435/15; 435/4; 435/19; 435/18; 435/22; 435/23; 435/24; 435/27; 435/28; 435/25; 435/21

(57) ABSTRACT

The present invention relates to methods of determining enzyme activity in a fluid, wherein the activity over time provides a viscosity-change in the fluid, by the use of a device (FIG. 1) equipped with at least one pressure sensor (FIG. 1 (4)) to determine the change in the fluid viscosity over time as a measure of the enzyme activity.

### FIELD OF THE INVENTION

The present invention relates to methods of determining enzyme activity in a fluid, wherein the enzyme activity over time provides a viscosity-change in the fluid, measured by the use of a pipetting system (FIG. 1) equipped with at least one pressure sensor (FIG. 1(4)) to determine the pressure changes in the headspace of the pipetting system during aspiration and dispensation.

The determination of enzyme activities in-line and in real-time is highly interesting in a multitude of industrial processes, where assays are needed to select the right enzyme for the application. The application of a real-time viscosity assay that also works well for very small volumes, even in SBS microplate scale, are virtually endless, they include testing of animal feed enzymes, enzymes for baking purposes, washing enzymes, dishwashing enzymes, high-throughput robotic screening etc.

### BACKGROUND OF THE INVENTION

Viscosity is a measure of the resistance of a fluid which is being deformed by either shear stress or extensional stress. In everyday terms (and for fluids only), viscosity is “thickness”. Thus, water is “thin”, having a lower viscosity, while honey is “thick”, having a higher viscosity. Accurate measurements of viscosity are important in many industrial processes, but have been tedious and difficult to carry out in-line or in close-to real-time.

Devices that measure viscosity of liquids are termed viscosimeters. Usually, viscometers only measure under one flow condition. In general, either the fluid remains stationary and an object moves through it, or the object is stationary and the fluid moves past it. The drag caused by relative motion of the fluid and a surface is a measure of the viscosity. The flow conditions must have a sufficiently small value of Reynolds number for there to be laminar flow. Many types of viscosimeters have been devised, such as, U-tube viscosimeters, falling sphere or falling piston viscosimeters, vibrational or rotational viscosimeters etc. One of the most common instruments for measuring kinematic viscosity is the glass capillary viscometer.

In many situations, we are concerned with the ratio of the viscous force to the inertial force, the latter characterised by the fluid density p. This ratio is characterised by the kinematic viscosity (Greek letter nu, v), defined as follows:

$$ν = \frac{μ}{ρ} ,$$

The SI unit of v is m²/s. The cgs physical unit for kinematic viscosity is the stokes (St), named after George Gabriel Stokes. It is sometimes expressed in terms of centistokes (cSt or ctsk). In U.S. usage, stoke is sometimes used as the singular form.

1 St=1 cm²·s⁻¹=10⁻⁴ m²·s⁻¹.

1 cSt=1 mm²·s⁻¹=10⁻⁶m²·s⁻¹.

Water at 20° C. has a kinematic viscosity of about 1 cSt.

Automated pipetting systems are available from a number of commercial suppliers and such systems are well-known in the art, including, the addition of pressure sensors to monitor the pipetting process (WO 9308475; Abbott Lab. EP 0705424; Boehringer Mannhei. EP 0990909; Hoffmann-La Roche. EP 1745851; Tecan Trading AG. WO 2009104065; Gilson SAS).

Pressure-monitoring during an automated pipetting process is carried out for various purposes in a number of pipetting applications, e.g., to discard irregular pipetting processes (WO 2002073215; Hamilton Bonaduz AG) or to provide fully automatic control of the pipetting process (EP 1614468; Hamilton Bonaduz AG).

It has recently been stated (EP 2009449; Hamilton Bonaduz AG), that the larger the surface tension and the viscosity of a liquid is, the lower is the pressure inside the pipette tip at the time the liquid starts flowing into the pipette tip and the larger is the absolute value of the slope of the time characteristics of pressure when the plunger moves without any flow of liquid taking place yet. As a further general rule, it was stated, that the larger the viscosity of a liquid is, the smaller is generally the slope of the time characteristics of pressure when the movement of the plunger has stopped, but the flow of liquid is still continuing. However, it was concluded, that all these general rules are of a more qualitative nature, and therefore, despite the fact that they seem quite intuitive, are difficult to evaluate quantitatively for calculating differences in process variables to be applied when liquids having differing physical characteristics are to be dosed using a pipetting device.

In the art of industrial enzyme applications there is always a need for screening-assays that are suitable for large-scale automation in so-called high throughput screening setups, especially measurements of viscosity have been a challenge.

### SUMMARY OF THE INVENTION

The present invention provides a method for easy and label-free indirect determination of enzyme activity in a fluid by the use of pressure measurements in an automated pipetting system, for example, the Hamilton MICROLAB® ELISA STAR^{let} liquidhandler (Hamilton Robotics Inc./Hamilton Bonaduz AG).

A pressure transducer or sensor inside the air displacement barrel of the pipette measures the pressure inside the barrel during aspiration and/or dispensation. The data from this sensor changes as the pipette tip approaches the liquid surface, touches the surface and drives below, as well as during pipetting, depending on the viscosity of the fluid.

The inventors have demonstrated that such data can be used not only to control pipetting in real-time, as routinely done in the commercially available automated pipetting systems, but also to determine changes in viscosity of a fluid or liquified substrate over time resulting from enzymatic activity. The pressure data is compared with suitable liquid viscosity standard(s) to determine the change in viscosity over time, thereby providing an indirect determination of enzyme activity. Such a Viscosity-Pressure assay or “ViPr assay” provides several benefits:
The enzyme activity of many samples can be measured fast—up to 96 samples in 5 minutes in the experimental setup demonstrated below.
The enzyme activity is determined label-free and non-destructive.
The enzyme activity can be monitored in real-time thereby providing excellent process control.
Samples differing in viscosity by as little as 2 cSt can be significantly differentiated.

Many applications of the ViPr assay are envisioned, such as, in the studies of animal nutrition, where it allows the study of non-starch polysaccharide degrading enzymes, or in the studies of biomass degradation, e.g. for bioethanol or biogas production, in food studies incl. dough and youghurt, or in the production of biopolymers, e.g., hyaluronic acid.

The ViPr assay allows fast and effective screening for improvement of existing enzyme activities as well as application relevant screening on real-world substrates in the early discovery phase when searching for new activities that are difficult to assay with current technologies.

Relative viscosity values can be derived from the pressure values measured during dispensing or aspirating a liquid by relating the obtained values to water or another known viscosity standard. Relative viscosity of solutions showing large differences in viscosity can be analyzed and the measured values correlated to data obtained by conventional viscosimeters. Even the viscosity of cake dough has been successfully measured in a preliminary test (not shown).

Typically, a first measurement will be taken before the enzyme is added to the fluid, to establish a baseline, and then one or more additional measurement(s) are taken over time after addition of the enzyme at timepoint 0. However, it is also possible to add the enzyme first and then take the measurements afterwards over time.

Both endpoint and kinetic analysis of viscosity open a new way of screening enzyme activities at a rate or throughput which has not been possible before.

Accordingly, in a first aspect, the present invention relates to a method of determining enzyme activity in a fluid comprising at least one substrate for said enzyme activity, wherein the activity on the substrate over time provides a viscosity-change in the fluid, said method comprising:
(a) aspirating and/or dispensing at least two samples from the fluid over a suitable timespan using a device (FIG. 1) equipped with at least one pressure sensor (FIG. 1(4)) capable of measuring the changing pressure in the headspace (FIG. 1(3)) before, during and after aspiration and/or dispensation of the samples (FIG. 2), wherein the fluid is contacted with at least one enzyme prior to or after at least the first sample is aspirated and/or dispensed;
(b) correlating the obtained pressure data in (a) with the pressure data of one or more known viscosity standard aspirated and/or dispensed under comparable conditions, whereby the viscosities of the samples are determined; and
(c) calculating the enzyme activity in the fluid based on the change in the fluid viscosity in the timespan between the samples.

In another aspect, the invention relates to a method of determining enzyme activity in a fluid comprising at least one substrate for said enzyme activity, wherein the activity on the substrate over time provides a viscosity-change in the fluid, said method comprising:
(a) contacting the fluid with at least one enzyme;
(b) aspirating and/or dispensing at least two samples from the fluid over a suitable timespan using an automated pipetting system (FIG. 1) equipped with at least one pressure sensor (FIG. 1(4)) capable of measuring the changing pressure in the headspace (FIG. 1(3)) before, during and after aspiration and/or dispensation of the samples (FIG. 2);
(c) correlating the obtained pressure data in (b) with the pressure data of one or more known viscosity standard aspirated and/or dispensed under comparable conditions, whereby the viscosities of the samples are determined; and
(d) calculating the enzyme activity in the fluid based on the change in the fluid viscosity in the timespan between the samples.

### BRIEF DESCRIPTION OF THE FIGURES

FIG. 1 shows in a schematic overview an example of how an automated pipette suitable for the method of the invention might be constructed; other ways of constructing an automated pipette are well known in the art.

FIG. 2 shows some theoretical schematic typical pressure curves that would result from faulty air-based pipetting action using an automated pipette as depicted in FIG. 1; the instrument is capable of detecting clots or empty wells during aspiration and dispensing steps in real time.

FIG. 3 shows pressure curves for aspiration of 6 glycerol standards with concentrations as indicated from 0 to 60%(v/v) done in 8 independent channels per concentration. Following a steep non-linear increase from the start level, the pressure changes linearly before returning smoothly to atmospheric pressure levels.

FIG. 4 shows pressure curves for dispensing the same 6 glycerol standards with concentrations as indicated from 0 to 60%(v/v) done in 8 independent channels per concentration. Following a steep non-linear decrease from the start level, the pressure changes linearly before returning abruptly to atmospheric pressure levels.

FIG. 5 shows the results from Example 1, where the average viscosities of standard glycerol solutions measured by the ViPr assay (aspirating step) are compared with the corresponding dynamic viscosities from literature at 30° C.

FIG. 6 shows the results from Example 1, where the average viscosities of standard glycerol solutions measured by the ViPr assay (dispensing step) are compared with the corresponding dynamic viscosities from literature at 30° C.

FIG. 7 shows the results from Example 2, where the viscosity (cSt) of high range viscosity standards were plotted against the relative viscosity as measured in the ViPr assay.

FIG. 8 shows the results from Example 2, where the Viscosity [cSt] of the low range viscosity standards were plotted against the relative viscosity as measured in the ViPr assay.

FIG. 9 shows the results from Example 3, where the hydrolysis by a xylanase (BioFeed® Wheat, Novozymes NS, 5 FXU/g) of non-starch polysaccharides (NSP) extracted from rye is measured by the ViPr assay over time.

FIGS. 10 and 11 show the results from Example 4, where the hydrolysis of biomass by a commercially available cellulase complex is measured by the ViPr assay over time.

FIG. 12 shows the results from Example 5, where the hydrolysis of polygalacturonic acid (PGU) by a commercially available pectinase is measured by the ViPr assay over time.

FIG. 13 shows the results from Example 6, where the hydrolysis of rye arabinoxylan (Rye Hour; Megazymes) by four different xylanases were measured by the ViPr assay over time.

### Definitions

### Viscosity

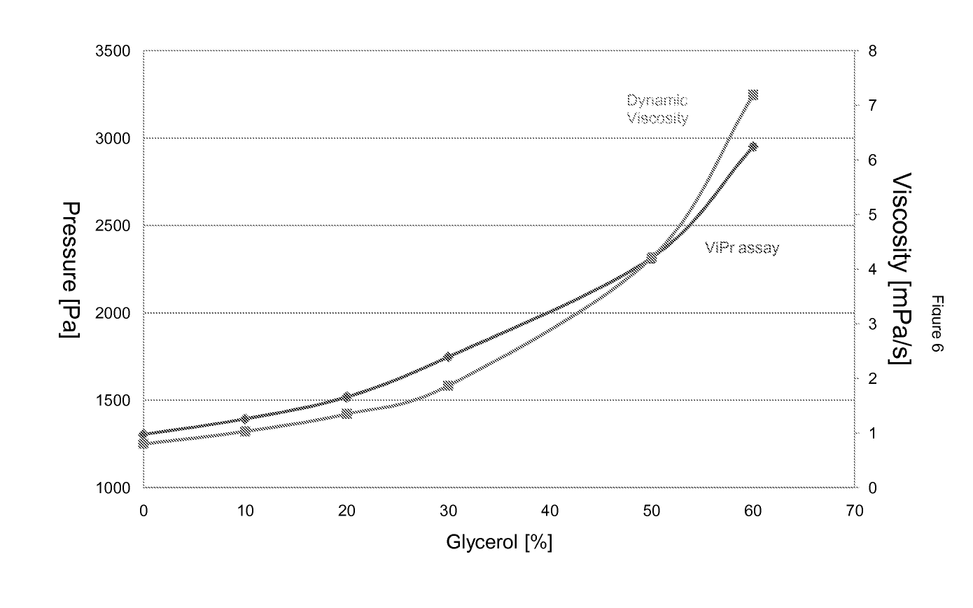

In the present context the viscosity of a fluid is determined by pressure measurements in the headspace of a pipetting device (FIGS. 6, 7 and 8) before, during and/or after aspiration and/or dispensation of at least two samples of the fluid over a suitable timespan. The first sample establishes a starting point and the second sample(s) shows a(ny) change in viscosity as a change in pressure. The pressure measurements are then correlated with those of one or more known viscosity standard(s) measured under identical or comparable conditions to determine the viscosities of the fluid samples. The change in the fluid viscosity during the timespan between the at least two samples is a measure of the enzyme activity on the respective substrate(s) in the fluid.

### Xylanolytic Activity, FXU

The xylanolytic activity can be expressed in FXU-units, determined at pH 6.0 with remazol-xylan (4-O-methyl-D-glucurono-D-xylan dyed with Remazol Brilliant Blue R, Fluka) as substrate.

A xylanase sample is incubated with the remazol-xylan substrate. The background of non-degraded dyed substrate is precipitated by ethanol. The remaining blue colour in the supernatant (as determined spectrophotometrically at 585 nm) is proportional to the xylanase activity, and the xylanase units are then determined relatively to an enzyme standard at standard reaction conditions, i.e. Substrate concentration 0.45% w/v, Enzyme concentration 0.04-0.14 FXU(S)/mL at 50.0° C., pH 6.0, and in 30 minutes reaction time. Xylanase activity in FXU(S) is measured relative to a Novozymes FXU(S) enzyme standard comprising the monocomponent xylanase preparation Shearzyme from Aspergillus aculeatus.

### Cellulose

Cellulose is a polymer of the simple sugar glucose covalently bonded by beta-1,4-linkages. Many microorganisms produce enzymes that hydrolyze beta-linked glucans. These enzymes include endoglucanases, cellobiohydrolases, and beta-glucosidases. Endoglucanases digest the cellulose polymer at random locations, opening it to attack by cellobiohydrolases. Cellobiohydrolases sequentially release molecules of cellobiose from the ends of the cellulose polymer. Cellobiose is a water-soluble beta-1,4-linked dimer of glucose. Beta-glucosidases hydrolyze cellobiose to glucose. WO 2005/074647 discloses isolated polypeptides having cellulolytic enhancing activity and polynucleotides thereof from Thielavia terrestris. WO 2005/074656 discloses an isolated polypeptide having cellulolytic enhancing activity and a polynucleotide thereof from Thermoascus aurantiacus. U.S. Published Application Serial No. 2007/0077630 discloses an isolated polypeptide having cellulolytic enhancing activity and a polynucleotide thereof from Trichoderma reesei.

### Endoglucanase

The term “endoglucanase” is defined herein as an endo-1,4-(1,3;1,4)-beta-D-glucan 4-glucanohydrolase (E.C. No. 3.2.1.4), which catalyses endohydrolysis of 1,4-beta-D-glycosidic linkages in cellulose, cellulose derivatives (such as carboxymethyl cellulose and hydroxyethyl cellulose), lichenin, beta-1,4 bonds in mixed beta-1,3 glucans such as cereal beta-D-glucans or xyloglucans, and other plant material containing cellulosic components. For purposes of the present invention, endoglucanase activity is determined using carboxymethyl cellulose (CMC) hydrolysis according to the procedure of Ghose, 1987, Pure and Appl. Chem. 59: 257-268.

### Cellobiohydrolase

The term “cellobiohydrolase” is defined herein as a 1,4-beta-D-glucan cellobiohydrolase (E.C. 3.2.1.91), which catalyzes the hydrolysis of 1,4-beta-D-glucosidic linkages in cellulose, cellooligosaccharides, or any beta-1,4-linked glucose containing polymer, releasing cellobiose from the reducing or non-reducing ends of the chain. For purposes of the present invention, cellobiohydrolase activity is determined according to the procedures described by Lever et al., 1972, Anal. Biochem. 47: 273-279 and by van Tilbeurgh et al., 1982, FEBS Letters 149: 152-156; van Tilbeurgh and Claeyssens, 1985, FEBS Letters 187: 283-288. In the present invention, the Lever et al. method was employed to assess hydrolysis of cellulose in corn stover, while the method of van Tilbeurgh et al. was used to determine the cellobiohydrolase activity on a fluorescent disaccharide derivative.

### Beta-glucosidase

The term “beta-glucosidase” is defined herein as a beta-D-glucoside glucohydrolase (E.C. 3.2.1.21), which catalyzes the hydrolysis of terminal non-reducing beta-D-glucose residues with the release of beta-D-glucose. For purposes of the present invention, beta-glucosidase activity is determined according to the basic procedure described by Venturi et al., 2002, J. Basic Microbiol. 42: 55-66, except different conditions were employed as described herein. One unit of beta-glucosidase activity is defined as 1.0 μmole of p-nitrophenol produced per minute at 50° C., pH 5 from 4 mM p-nitrophenyl-beta-D-glucopyranoside as substrate in 100 mM sodium citrate, 0.01% TWEEN® 20.

### Glycoside Hydrolases

The term “Family 1, Family 3, Family 5, Family 6, Family 7, Family 9, Family 12, Family 45, Family 61, or Family 74 glycoside hydrolase” or “Family GH1, Family GH3, Family GH5, Family GH6, Family GH7, Family GH9, Family GH12, Family GH45, Family GH61, or Family GH74” is defined herein as a polypeptide falling into the glycoside hydrolase Family 1, Family 3, Family 5, Family 6, Family 7, Family 9, Family 12, Family 45, Family 61, or Family 74, respectively, according to Henrissat B., 1991, A classification of glycosyl hydrolases based on amino-acid sequence similarities, Biochem. J. 280: 309-316, and Henrissat B., and Bairoch A., 1996, Updating the sequence-based classification of glycosyl hydrolases, Biochem. J. 316: 695-696. Presently, Henrissat lists the GH61 Family as unclassified indicating that properties such as mechanism, catalytic nucleophile/base, catalytic proton donors, and 3-D structure are not known for polypeptides belonging to this family.

### Cellulose-Containing Material

The predominant polysaccharide in the primary cell wall of biomass is cellulose, the second most abundant is hemi-cellulose, and the third is pectin. The secondary cell wall, produced after the cell has stopped growing, also contains polysaccharides and is strengthened by polymeric lignin covalently cross-linked to hemicellulose. Cellulose is a homopolymer of anhydrocellobiose and thus a linear beta-(1-4)-D-glucan, while hemicelluloses include a variety of compounds, such as xylans, xyloglucans, arabinoxylans, and mannans in complex branched structures with a spectrum of substituents. Although generally polymorphous, cellulose is found in plant tissue primarily as an insoluble crystalline matrix of parallel glucan chains. Hemicelluloses usually hydrogen bond to cellulose, as well as to other hemicelluloses, which help stabilize the cell wall matrix.

The cellulose-containing material can be any material containing cellulose. Cellulose is generally found, for example, in the stems, leaves, hulls, husks, and cobs of plants or leaves, branches, and wood of trees. The cellulose-containing material can be, but is not limited to, herbaceous material, agricultural residues, forestry residues, municipal solid wastes, waste paper, and pulp and paper mill residues. The cellulose-containing material can be any type of biomass including, but not limited to, wood resources, municipal solid waste, wastepaper, crops, and crop residues (see, for example, Wiselogel et al., 1995, in Handbook on Bioethanol (Charles E. Wyman, editor), pp.105-118, Taylor & Francis, Washington D.C.; Wyman, 1994, Bioresource Technology 50: 3-16; Lynd, 1990, Applied Biochemistry and Biotechnology 24/25: 695-719; Mosier et al., 1999, Recent Progress in Bioconversion of Lignocellulosics, in Advances in Biochemical Engineering/Biotechnology, T. Scheper, managing editor, Volume 65, pp. 23-40, Springer-Verlag, N.Y.). It is understood herein that the cellulose-containing material is preferably in the form of lignocellulose, e.g., a plant cell wall material containing lignin, cellulose, and hemicellulose in a mixed matrix.

In a preferred aspect, the cellulose-containing material is corn stover. In another preferred aspect, the cellulose-containing material is corn fiber. In another preferred aspect, the cellulose-containing material is corn cobs. In another preferred aspect, the cellulose-containing material is switch grass. In another preferred aspect, the cellulose-containing material is rice straw. In another preferred aspect, the cellulose-containing material is paper and pulp processing waste. In another preferred aspect, the cellulose-containing material is woody or herbaceous plants. In another preferred aspect, the cellulose-containing material is bagasse.

The cellulose-containing material may be used as is or may be subjected to pretreatment, using conventional methods known in the art. For example, physical pretreatment techniques can include various types of milling, irradiation, steaming/steam explosion, and hydrothermolysis; chemical pretreatment techniques can include dilute acid, alkaline, organic solvent, ammonia, sulfur dioxide, carbon dioxide, and pH-controlled hydrothermolysis; and biological pretreatment techniques can involve applying lignin-solubilizing microorganisms (see, for example, Hsu, T.-A., 1996, Pretreatment of biomass, in Handbook on Bioethanol: Production and Utilization, Wyman, C. E., ed., Taylor & Francis, Washington, DC, 179-212; Ghosh, P., and Singh, A., 1993, Physicochemical and biological treatments for enzymatic/microbial conversion of lignocellulosic biomass, Adv. Appl. Microbiol. 39: 295-333; McMillan, J. D., 1994, Pretreating lignocellulosic biomass: a review, in Enzymatic Conversion of Biomass for Fuels Production, Himmel, M. E., Baker, J. O., and Overend, R. P., eds., ACS Symposium Series 566, American Chemical Society, Washington, DC, chapter 15; Gong, C. S., Cao, N. J., Du, J., and Tsao, G. T., 1999, Ethanol production from renewable resources, in Advances in Biochemical Engineering/Biotechnology, Scheper, T., ed., Springer-Verlag Berlin Heidelberg, Germany, 65: 207-241; Olsson, L., and Hahn-Hagerdal, B., 1996, Fermentation of lignocellulosic hydrolysates for ethanol production, Enz. Microb. Tech. 18: 312-331; and Vallander, L., and Eriksson, K.-E. L., 1990, Production of ethanol from lignocellulosic materials: State of the art, Adv. Biochem. Eng./Biotechnol. 42: 63-95).

### Pre-Treated Corn Stover

The term “PCS” or “Pre-treated Corn Stover” is defined herein as a cellulose-containing material derived from corn stover by treatment with heat and dilute acid.

### DETAILED DESCRIPTION OF THE INVENTION

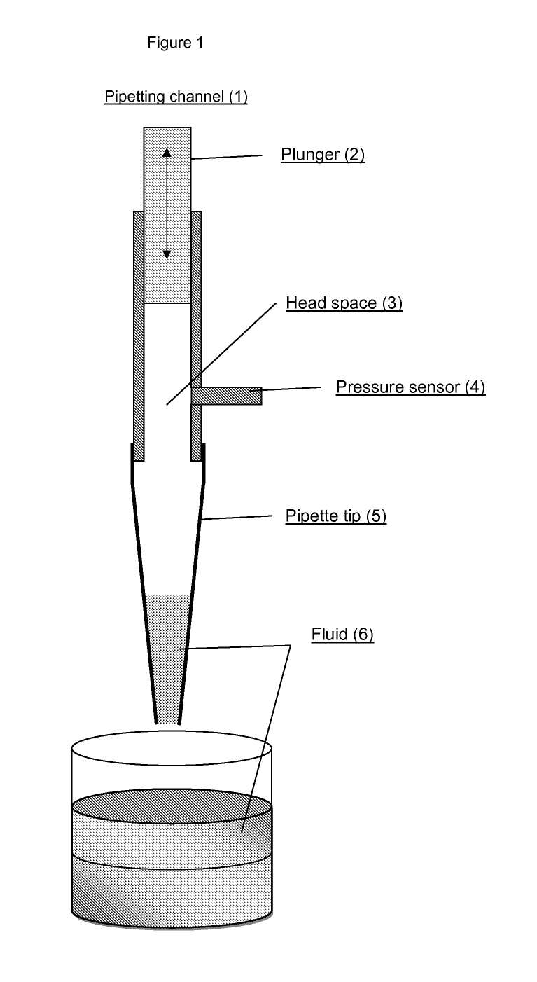

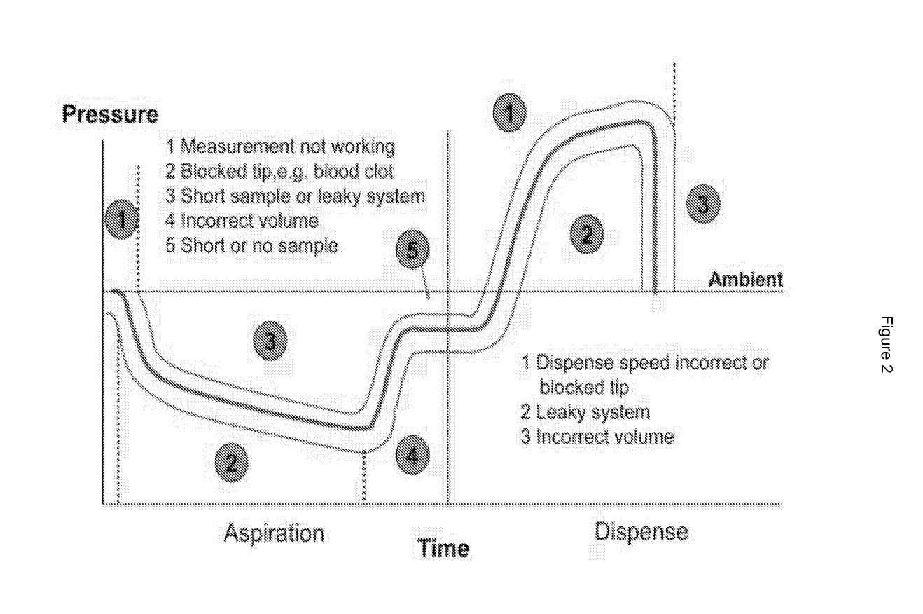

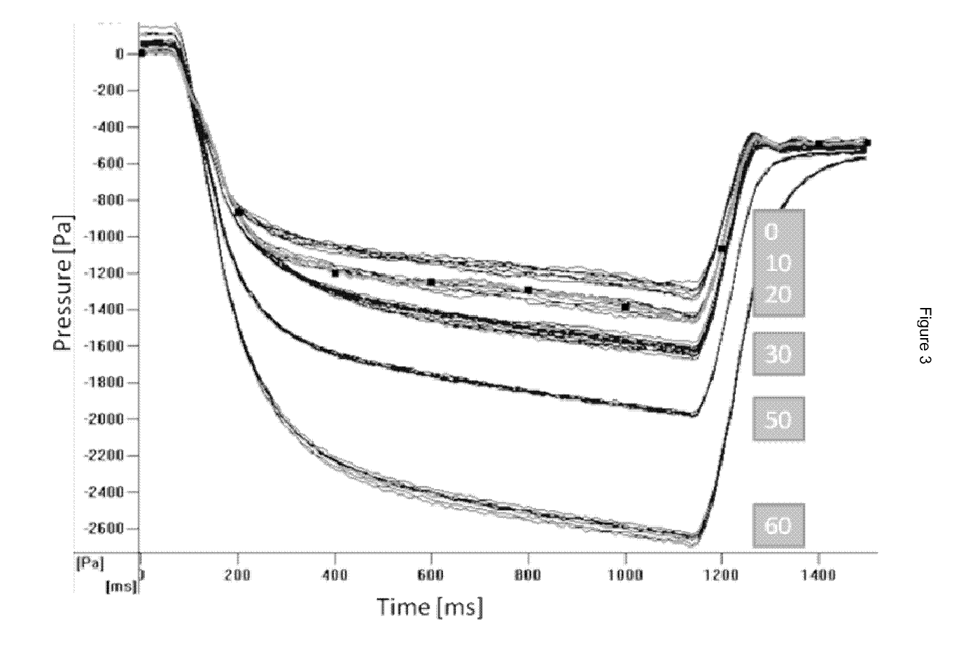

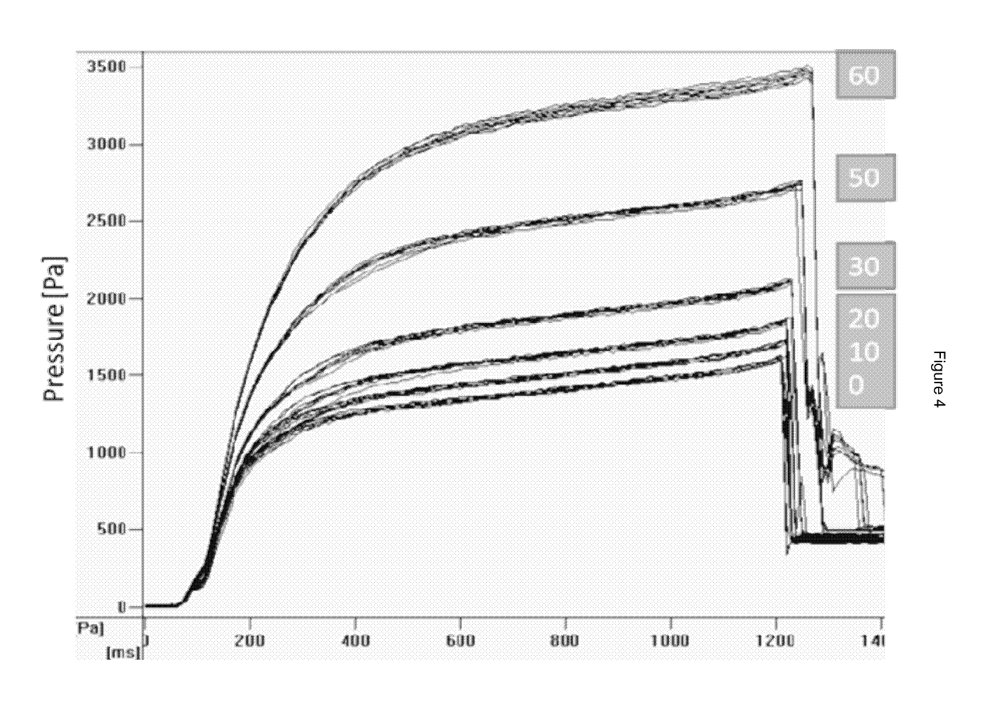

In its most general form, the instant invention relates to a method of determining enzyme activity in a fluid comprising at least one substrate for said enzyme activity, wherein the activity on the substrate over time provides a viscosity-change in the fluid, said method comprising:
(a) aspirating and/or dispensing at least two samples from the fluid over a suitable timespan using a device (FIG. 1) equipped with at least one pressure sensor (FIG. 1(4)) capable of measuring the changing pressure in the headspace (FIG. 1(3)) before, during and after aspiration and/or dispensation of the samples (FIG. 2), wherein the fluid is contacted with at least one enzyme prior to or after at least the first sample is aspirated and/or dispensed;
(b) correlating the obtained pressure data in (a) with the pressure data of one or more known viscosity standard aspirated and/or dispensed under comparable conditions, whereby the viscosities of the samples are determined; and
(c) calculating the enzyme activity in the fluid based on the change in the fluid viscosity in the timespan between the samples.

Another aspect of the invention relates to a method of determining enzyme activity in a fluid comprising at least one substrate for said enzyme activity, wherein the activity on the substrate over time provides a viscosity-change in the fluid, said method comprising:
(a) contacting the fluid with at least one enzyme;
(b) aspirating and/or dispensing at least two samples from the fluid over a suitable timespan using an automated pipetting system (FIG. 1) equipped with at least one pressure sensor (FIG. 1(4)) capable of measuring the changing pressure in the headspace (FIG. 1(3)) before, during and after aspiration and/or dispensation of the samples (FIG. 2);
(c) correlating the obtained pressure data in (b) with the pressure data of one or more known viscosity standard aspirated and/or dispensed under comparable conditions, whereby the viscosities of the samples are determined; and
(d) calculating the enzyme activity in the fluid based on the change in the fluid viscosity in the timespan between the samples.

A non-Newtonian fluid is a fluid whose flow properties are not described by a single constant value of viscosity. Many polymer solutions and molten polymers are non-Newtonian fluids, as are many commonly found substances such as ketchup, starch suspensions, paint, blood and shampoo. In a Newtonian fluid, the relation between the shear stress and the strain rate is linear (and if one were to plot this relationship, it would pass through the origin), the constant of proportionality being the coefficient of viscosity. In a non-Newtonian fluid, the relation between the shear stress and the strain rate is nonlinear, and can even be time-dependent.

There are fluids which have a linear shear stress/shear strain relationship which require a finite yield stress before they begin to flow. That is the shear stress, shear strain curve doesn't pass through the origin. These fluids are called Bingham plastics. Several examples are clay suspensions, drilling mud, toothpaste, mayonnaise, chocolate, and mustard. The classic case is ketchup which will not come out of the bottle until you stress it by shaking.

In a preferred embodiment, the fluid is a slurry or a non-newtonian liquid. In another preferred embodiment, the fluid is a Bingham plastic.

Any enzyme substrate that may be found in a fluid, added to a fluid or liquefied may be suitable in the method of the invention, an exhaustive list would be virtually endless. Preferably, the substrate comprises protein, lipid, cellulose, hemicellulose, lignin, starch or a non-starch polysaccharide.

The method of the invention may be employed to determine the activity of a single enzyme, several enzymes or even an enzyme complex. In a preferrred embodiment, the fluid is contacted with two or more enzymes.

The viscosity values determined in the automated pipetting system of the invention change over time as a result of the activity of the enzyme(s) in the fluid and they may increase or decrease. In a preferred embodiment, the at least one enzyme is capable of lowering or increasing the viscosity of the fluid over time.

It is envisioned that any enzymatic activity capable of producing a viscosity change in a fluid comprising a substrate for said activity may be determined by the method of the first aspect of the invention. Preferably, in the method of the first aspect, the at least one enzyme comprises an oxidoreductase, transferase, hydrolase, lyase, isomerase, or ligase; preferably the at least one enzyme comprises an aminopeptidase, amylase, carbohydrase, carboxypeptidase, catalase, cellulase, chitinase, cutinase, cyclodextrin glycosyltransferase, deoxyribonuclease, esterase, alpha-galactosidase, beta-galactosidase, glucoamylase, alpha-glucosidase, beta-glucosidase, invertase, laccase, another lipase, mannosidase, mutanase, oxidase, pectinolytic enzyme, peroxidase, phytase, polyphenoloxidase, proteolytic enzyme, ribonuclease, transglutaminase or xylanase.

The present invention is further described by the following examples that should not be construed as limiting the scope of the invention.

The device used for the methods of the invention is preferably a pipette, and more preferably the device is an automated pipette or pipetting system, such as, the Hamilton MICROLAB® ELISA STAR^{let} liquidhandler (Hamilton Robotics Inc./Hamilton Bonaduz AG).

### EXAMPLES

The invention described and claimed herein is not to be limited in scope by the specific aspects herein disclosed, since these aspects are intended as illustrations of several aspects of the invention. Any equivalent aspects are intended to be within the scope of this invention. Indeed, various modifications of the invention in addition to those shown and described herein will become apparent to those skilled in the art from the foregoing description. Such modifications are also intended to fall within the scope of the appended claims. In the case of conflict, the present disclosure including definitions will control.

Chemicals used as buffers and substrates were commercial products of at least reagent grade.

### Equipment

An automated microtiter-plate pipetting station equipped with a pressure sensor inside the air displacement barrel of each pipette was employed in the following experiments; the MICROLAB® ELISA STAR^{let} liquidhandler (Hamilton Robotics).

The MICROLAB® ELISA STAR^{let} liquidhandler has 8 pipetting channels: Each channel can aspirate up to a volume of 1 ml and the channels are built upon air-displacement technology, which is analogous to a hand held electronic pipette. To aspirate within different volume ranges the channels can accommodate a range of tips with volume from 10, 50, 300 to 1000 μl.

The liquidhandler has a pressure sensor located in the headspace of each pipetting channel (see FIG. 1). Pressure data from each sensor is collected by suitable software running on a computer, for example, by the “Total Aspiration Dispense Monitoring” (TADM) software of the MICROLAB® ELISA STAR^{let} liquidhandler (Hamilton Robotics).

During aspiration the plunger moves upwards and generates under pressure compared to the atmospheric pressure. The pressure in the headspace above the liquid is constantly measured by the pressure sensor. During dispensing the plunger moves downwards and generates an over pressure which is measured as well. The measured pressure values are affected by the different pipette tips that can be mounted on the channels as they have varying opening sizes. In addition, the liquid to pipettip surface is altered as well and will influence the values. By changing the dispensing and aspirating speed e.g. from 0.5 μl to 500 μl/s the magnitude of the pressure measured will be changed accordingly. The datapoints are collected every 10 ms in Pa and are stored in data files.

By monitoring the air-based pipetting action, the instrument detects clots or empty wells during aspiration and dispensing steps in real time (see FIG. 2).

The Hamilton Liquidhandler was tested to measure relative viscosity in the following experiments:

1. Viscosity of glycerol dilutions.

2. Viscosity of commercial viscosity standards.

3. Hydrolysis of NSP by xylanase measured by viscosity.

### Example 1

### Viscosity of Glycerol Dilutions

Glycerol dilutions were prepared ranging from 0-60% (v/v) glycerol. The solutions were transferred to a 96 deepwell microtiter plate with 1.5 ml of each dilution distributed in 8 wells. Using a MICROLAB® ELISA STAR^{let} liquidhandler (Hamilton Robotics) 250 μl of each solution was aspirated at 2 mm below surface (8 channels in parallel, pressure sensor to find liquid surface) and dispensed back to the same well from 5 mm above well.

The TADM (Total Aspiration Dispense Monitoring) software from Hamilton was used to monitor the pressure during aspiration and dispensing under the following conditions:
Ambient temperature.
300 μl tip with filter
250 μl volume to aspirate & dispense

The “Liquid Detail” settings for aspiration of glycerol in the TADM software were edited in the “Edit Liquid Class” menu, as follows:
Liquid device: 1000 μl channels.
Liquid: Glycerin 80%
Tip type: 300 μl Standard Volume Tip (0)
Dispense mode: Jet Empty Tip
Pressure LLD sensitivity: Low
Max height difference: 0.

| | Aspirate | Dispense |
|---|---|---|
| Flow rate (μl/s) | 100 | 40 |
| Mix flow rate (μl/s) | 20 | 1 |
| Air transport vol. (μl) | 5 | 5 |
| Blowout vol. (μl) | 30 | 30 |
| Swap speed (mm/s) | 2 | 1 |
| Setting time (s) | 2 | 0 |
| Over-aspirate vol. (μl) | 0 | |
| Clot retract height (mm) | 0 | |
| Stop flow rate (mm/s) | | 20 |
| Stop back vol. (μl) | | 0 |

The “Liquid Detail” settings for dispensing glycerol in the TADM software were edited in the “Edit Liquid Class” menu, as follows:
Liquid device: 1000 μl channels.
Liquid: Glycerin 80%
Tip type: 1000 μl High Volume Tip (4)
Dispense mode: Jet Empty Tip
Pressure LLD sensitivity: Low
Max height difference: 0.

| | Aspirate | Dispense |
|---|---|---|
| Flow rate (μl/s) | 500 | 500 |
| Mix flow rate (μl/s) | 200 | 1 |
| Air transport vol. (μl) | 5 | 15 |
| Blowout vol. (μl) | 50 | 50 |
| Swap speed (mm/s) | 2 | 1 |
| Setting time (s) | 5 | 0 |
| Over-aspirate vol. (μl) | 0 | |
| Clot retract height (mm) | 0 | |
| Stop flow rate (mm/s) | | 250 |
| Stop back vol. (μl) | | 0 |

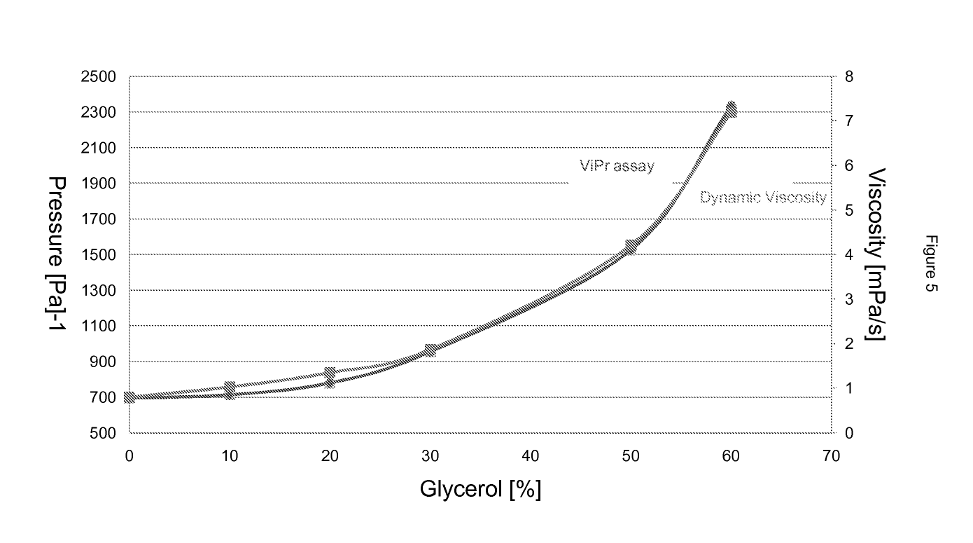

Pressure data from 1000 ms aspiration was extracted from the TADM data file to a spreadsheet, where the 8 measurements from each channel were averaged and then compared to the corresponding dynamic viscosities at 30° C. from literature (see table 1 below). The results are plotted in FIG. 5, which shows a clear correlation between the viscosity from literature and pressure data from the ViPr assay. Note: The CV for the 8 measurements of each solution is below 2%.

Pressure data from the dispensing was also compared to the data from literature and the result are plotted in FIG. 6. From the figure it is clear that glycerol solutions above a concentration of 20% show some separation, while the separation in the concentration range between 10 and 20% glycerol is less significant. The separation between 10 and 20% could be improved by choosing a 1000 μl filter tip and aspirating 500 μl.

TABLE 1
Viscosity of glycerine solutions (aq). Source: www.dow.com.
Viscosity of Aqueous Glycerine Solutions in Centipoises/mPa s

| Glycerine | Temperature (° C.) | | | | | | | | | | |
|---|---|---|---|---|---|---|---|---|---|---|---|
| percent weight | 0 | 10 | 20 | 30 | 40 | 50 | 60 | 70 | 80 | 90 | 100 |
| 0⁽¹⁾ | 1.79 | 1.31 | 1.01 | 0.801 | 0.656 | 0.549 | 0.469 | 0.406 | 0.357 | 0.317 | 0.284 |
| 10 | 2.44 | 1.74 | 1.31 | 1.03 | 0.826 | 0.680 | 0.575 | 0.500 | — | — | — |
| 20 | 3.44 | 2.41 | 1.76 | 1.35 | 1.07 | 0.879 | 0.731 | 0.635 | — | — | — |
| 30 | 5.14 | 3.49 | 2.50 | 1.87 | 1.46 | 1.16 | 0.956 | 0.816 | 0.690 | — | — |
| 40 | 8.25 | 5.37 | 3.72 | 2.72 | 2.07 | 1.62 | 1.30 | 1.09 | 0.918 | 0.763 | 0.668 |
| 50 | 14.6 | 9.01 | 6.00 | 4.21 | 3.10 | 2.37 | 1.86 | 1.53 | 1.25 | 1.05 | 0.910 |
| 60 | 29.9 | 17.4 | 10.8 | 7.19 | 5.08 | 3.76 | 2.85 | 2.29 | 1.84 | 1.52 | 1.28 |
| 65 | 45.7 | 25.3 | 15.2 | 9.85 | 6.80 | 4.89 | 3.66 | 2.91 | 2.28 | 1.86 | 1.55 |
| 67 | 55.5 | 29.9 | 17.7 | 11.3 | 7.73 | 5.50 | 4.09 | 3.23 | 2.50 | 2.03 | 1.68 |
| 70 | 76 | 38.8 | 22.5 | 14.1 | 9.40 | 6.61 | 4.86 | 3.78 | 2.90 | 2.34 | 1.93 |
| 75 | 132 | 65.2 | 35.5 | 21.2 | 13.6 | 9.25 | 6.61 | 5.01 | 3.80 | 3.00 | 2.43 |
| 80 | 255 | 116 | 60.1 | 33.9 | 20.8 | 13.6 | 9.42 | 6.94 | 5.13 | 4.03 | 3.18 |
| 85 | 540 | 223 | 109 | 58 | 33.5 | 21.2 | 14.2 | 10.0 | 7.28 | 5.52 | 4.24 |
| 90 | 1310 | 498 | 219 | 109 | 60.0 | 35.5 | 22.5 | 15.5 | 11.0 | 7.93 | 6.00 |
| 91 | 1590 | 592 | 259 | 127 | 68.1 | 39.8 | 25.1 | 17.1 | 11.9 | 8.62 | 6.40 |
| 92 | 1950 | 729 | 310 | 147 | 78.3 | 44.8 | 28.0 | 19.0 | 13.1 | 9.46 | 6.82 |
| 93 | 2400 | 860 | 367 | 172 | 89 | 51.5 | 31.6 | 21.2 | 14.4 | 10.3 | 7.54 |
| 94 | 2930 | 1040 | 437 | 202 | 105 | 58.4 | 35.4 | 23.6 | 15.8 | 11.2 | 8.19 |
| 95 | 3690 | 1270 | 523 | 237 | 121 | 67.0 | 39.9 | 26.4 | 17.5 | 12.4 | 9.08 |
| 96 | 4600 | 1580 | 624 | 281 | 142 | 77.8 | 45.4 | 29.7 | 19.6 | 13.6 | 10.1 |
| 97 | 5770 | 1950 | 765 | 340 | 166 | 88.9 | 51.9 | 33.6 | 21.9 | 15.1 | 10.9 |
| 98 | 7370 | 2460 | 939 | 409 | 196 | 104 | 59.8 | 38.5 | 24.8 | 17.0 | 12.2 |
| 99 | 9420 | 3090 | 1150 | 500 | 235 | 122 | 69.1 | 43.6 | 27.8 | 19.0 | 13.3 |
| 100 | 12070 | 3900 | 1410 | 612 | 284 | 142 | 81.3 | 50.6 | 31.9 | 21.3 | 14.8 |

⁽¹⁾Viscosity of water taken from “Properties of Ordinary Water-Substance.” N. E. Dorsey, p. 184. New York (1940).

### Example 2

### Viscosity Measurements of Commercial Viscosity Standards

The viscosities of commercial viscosity standards were tested on a MICROLAB® ELISA STAR^{let} liquidhandler (Hamilton Robotics) using the 1000 μl tips and 2 liquid classes (8 replicas per standard):
One liquid class for the high viscosity of standard N100.
One liquid class for the low viscosity range.

The “Liquid Detail” settings for the aspiration of the high viscosity liquid in the TADM software were edited in the “Edit Liquid Class” menu, as follows:
Liquid device: 1000 μl channels.
Liquid: Glycerin 80%
Tip type: 1000 μl High Volume Tip (4)
Dispense mode: Jet Empty Tip
Pressure LLD sensitivity: Low
Max height difference: 0.

| | Aspirate | Dispense |
|---|---|---|
| Flow rate (μl/s) | 200 | 300 |
| Mix flow rate (μl/s) | 200 | 1 |
| Air transport vol. (μl) | 5 | 15 |
| Blowout vol. (μl) | 50 | 50 |
| Swap speed (mm/s) | 2 | 1 |
| Setting time (s) | 1.5 | 0 |
| Over-aspirate vol. (μl) | 0 | |
| Clot retract height (mm) | 0 | |
| Stop flow rate (mm/s) | | 250 |
| Stop back vol. (μl) | | 0 |

The “Liquid Detail” settings for the aspiration of the low viscosity range liquids in the TADM software were edited in the “Edit Liquid Class” menu, as follows:
Liquid device: 1000 μl channels.
Liquid: Glycerin 80%
Tip type: 1000 μl High Volume Tip (4)
Dispense mode: Jet Empty Tip
Pressure LLD sensitivity: Low
Max height difference: 0.

| | Aspirate | Dispense |
|---|---|---|
| Flow rate (μl/s) | 50 | 50 |
| Mix flow rate (μl/s) | 100 | 1 |
| Air transport vol. (μl) | 5 | 15 |
| Blowout vol. (μl) | 50 | 50 |
| Swap speed (mm/s) | 2 | 1 |
| Setting time (s) | 1.5 | 0 |
| Over-aspirate vol. (μl) | 0 | |
| Clot retract height (mm) | 0 | |
| Stop flow rate (mm/s) | | 250 |
| Stop back vol. (μl) | | 0 |

TABLE 2
Viscosity standards.

| | Dynamic | Kinematic | |
|---|---|---|---|
| | viscosity | Viscosity | Density |
| | [cP] | [cSt] | [g/l] |
| N100 | 206.2 | 238.712665 | 0.8638 |
| Glycerol 87% | 109 | 88.61788618 | 1.23 |
| N10 | 14.06 | 16.79808841 | 0.837 |
| S6 | 7.237 | 8.792370307 | 0.8231 |
| S3 | 3.251 | 4.0190382 | 0.8089 |
| Water | 0.89 | 0.892678034 | 0.997 |

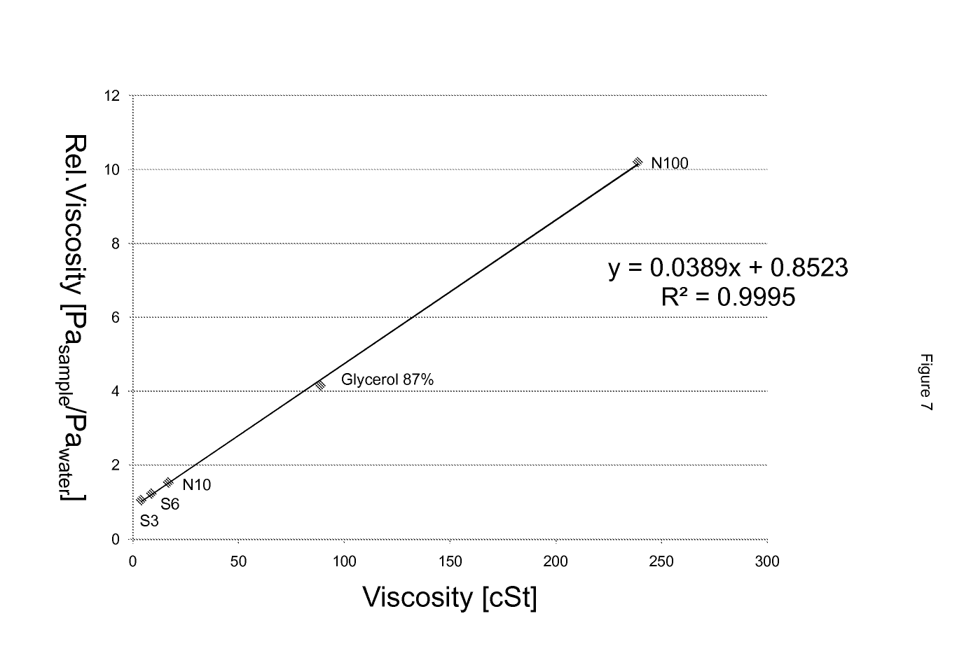

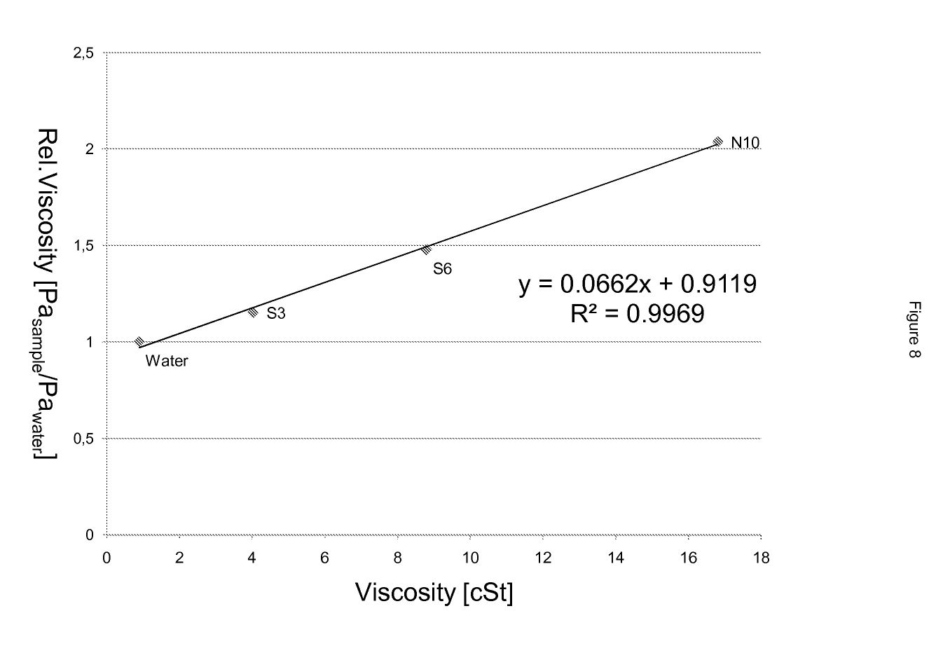

The ViPr assay pressure data from the aspiration step in TADM were corrected for density and transformed to relative viscosity by dividing the pressure measured for water with the pressure measured for the sample. These data were plotted against kinematic viscosity data in FIGS. 7 and 8, for the low viscosity and high viscosity standards, respectively. The plots in FIGS. 7 and 8 show for all standards a significant correlation between literature data and measured data from the ViPr assay.

### Example 3

### Measuring Enzymatic Activity by Viscosity

The non-starch polysaccharide (NSP) fraction in cereals can cause high viscosity in the digestive system of production animals and thereby reduce the uptake of nutrients. Xylanases can by degradation of arabinoxylans alleviate this anti-nutritional effect. When added to feeds (e.g. for monogastric animals, including poultry or swine) which contain cereals (e.g. barley, wheat, maize, rye, triticale or oats) they increase the breakdown of plant cell walls which leads to a better release of nutrients enclosed within the plant cell. In addition, xylanases they also assist in reducing viscosity caused by solubilised NSP components. The overall effect of the enzyme supplementation is improved growth rate and feed conversion.

Investigating the effects of enzymes on viscosity can be a tedious task, difficult to achieve and limited by the number of tests it is possible to carry out per day.

The potential of the ViPr assay technology in studying enzymatic activity was investigated by the hydrolysis of the substrate NSP by a xylanase. NSP was isolated by extracting rye in an acetate buffer at pH 5.0 (0.1M) at a concentration of 0.175 g/ml.

An enzyme dose of 50 FXU/kg rye material (Bio-Feed® Wheat, Novozymes NS, diluted to 50 FXU in water) was added to the positive control (NSP−rye+50 FXU/kg Rye) while the water was added to the negative control (NSP−rye).

At certain time points 1.5 ml solution was removed from both incubations and transferred to a well in a 96 well deep well plate. The change in viscosity was then measured by ViPr assay using a MICROLAB® ELISA STAR^{let} liquidhandler (Hamilton Robotics).

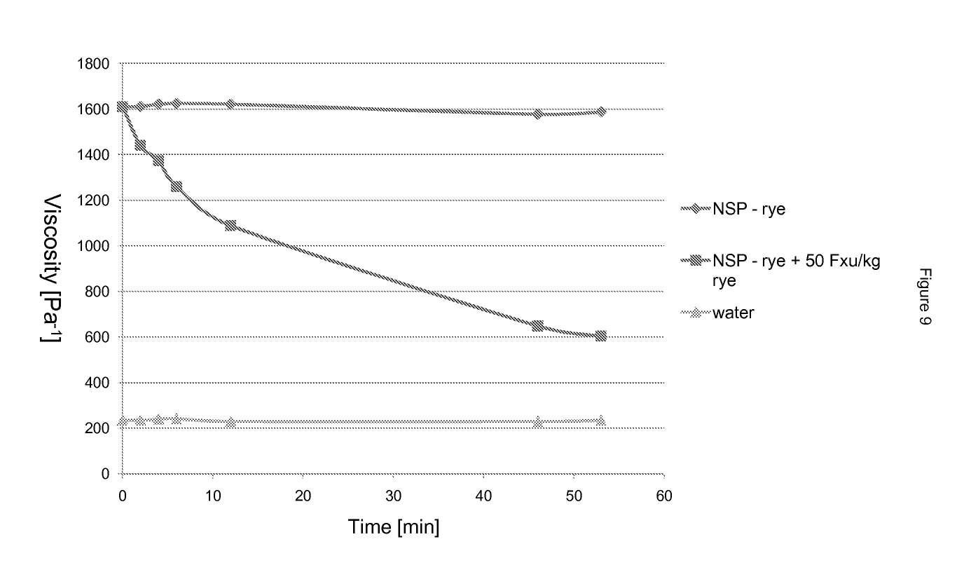

The pressure data (aspirate step) from the TADM software file was plotted against time in FIG. 9, which shows a clearly decreasing pressure difference to the atmospheric pressure, which in turn reflects a decrease of the viscosity in the sampled liquid over time.

### Example 4

### Label-Free Determination of Biomass Hydrolysis

The ViPr assay was applied to follow the hydrolysis of biomass by measuring the viscosity of enzyme treated samples in 24 well microtiter plates using a MICROLAB® ELISA STAR^{let} liquidhandler (Hamilton Robotics). The enzyme treated biomass is an examples of a non-newtonian liquid.

Firstly, in order to analyze biomass some hardware changes had to be made. The particles in the biomass material show a high affinity to each other and hence lead to clogging of the pipetting tips. Consequently, all measurements were done with custom made tips. 1000 μl Hamilton tips were cut and the upper part was connected to a 1000 μl wide bore pipette tip. This was necessary as the sample opening of a standard Hamilton tip is only has an outer diameter of 0.6 mm, whereas the wide bore tip has twice that (1.2 mm) and showed significantly less clogging with particulate material. Sealing between the two parts was done by several layers of parafilm.

In addition, the rack holding the tips had to be fitted to the dimensions in the MICROLAB® ELISA STAR^{let} liquidhandler (Hamilton Robotics), which required some adjustments of the deck layout as well, since the machine is very sensitive to even minor changes in the tip adapter.

Pretreated corn cobs or milled pretreated corn cobs having 10% or 2.5% dry matter content (DM), respectively, was used as substrate and treated with 10 mg/g (DM) “Cellic™ CTec”; a commercial cellulase complex, (Novozymes NS). The enzymatic hydrolysis reaction was incubated for 22 hours in a rotisserie incubator at 50° C. and pH 5.0.

Sample 1: Pretreated corn cobs.

Sample 2: Pretreated corn cols plus Cellic™ CTec.

Sample 3: Milled & pretreated corn cobs.

Sample 4: Milled & pretreated corn cobs plus Cellic™ CTec.

The four samples were measured (8 replicas) with a standard method using the TADM software enabled liquid class. 500 μl samples were aspirated from a 24 well plate (Whatman, 10 ml volume per well) and dispensed back to the aspiration well.

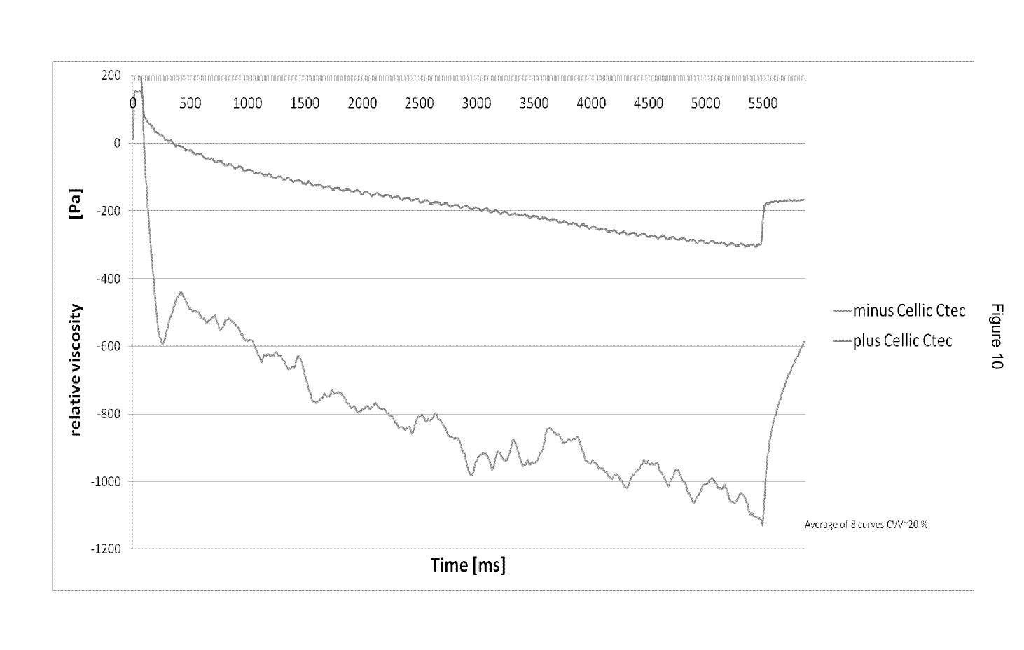

The resulting individual pressure curves from the aspirations fluctuated somewhat, probably due to partuclated material in the samples, but the averaged pressure curve shown in FIG. 10 is relatively smooth. The decrease in pressure can be related to decrease in viscosity and probably reflects the expected hydrolysis of the biomass material.

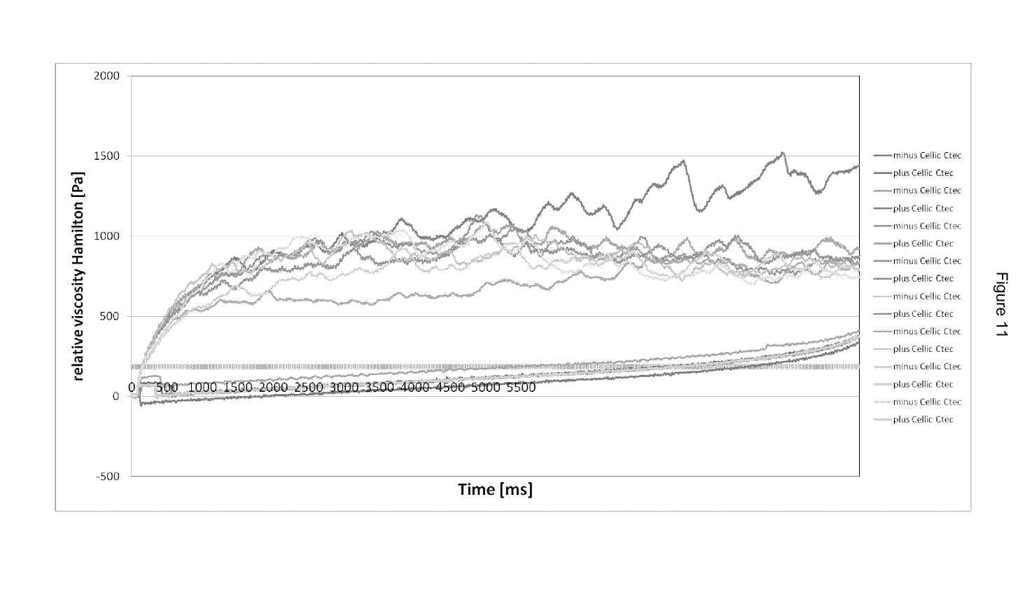

The resulting individual pressure curves from the dispensings are shown in FIG. 11; the lower curves are the samples treated with Cellic™ CTec and the upper curves are the samples without enzyme treatment. Besides 1-2 curves, these seem to be smoother compared to those from the aspiration step (not shown), hence most likely giving more reliable data.

Clearly, the ViPr assay can be used to determine enzymatic activity on complex substrates, such as, biomass.

### Example 5

### Measuring Pectinase Activity by Viscosity

We investigated the hydrolysis of the substrate polygalacturonic acid (PGA) by a commercially available pectinase, PECTINEX® ULTRA (Novozymes A/S, Denmark).

The PGA substrate (15.24 g/L) was dissolved in 70 mM phosphate; 30 mM citrate, which was then adjusted to pH 3.5 with 4M sodium hydroxide.

Pectinase was added to final concentrations in the reaction mixtures of: 6.9, 8.63 and 10 PGU/ml while only sample buffer (50 mM phosphate; 50 mM citrate; pH 3.5-RB) was added to the negative control.

One PGU (PolyGalacturonase Unit) is defined relative to a enzyme standard. Polygalacturonase hydrolyses polygalacturonic acid (PGA) and thereby reduces viscosity of the standard. This viscosity decrease is proportional to the polygalacturonase activity and is measured with a Vibrating spindle viscometer, MIVI (Sofraser, France). PGU is determined relative to an enzyme standard at standard reaction conditions: a PGA substrate concentration of 15.24 PGA g/L, an enzyme concentration of 7-10.5 PGU/ml at 30.0° C., adjusted to pH 3.5 and in 30 minutes reaction time.

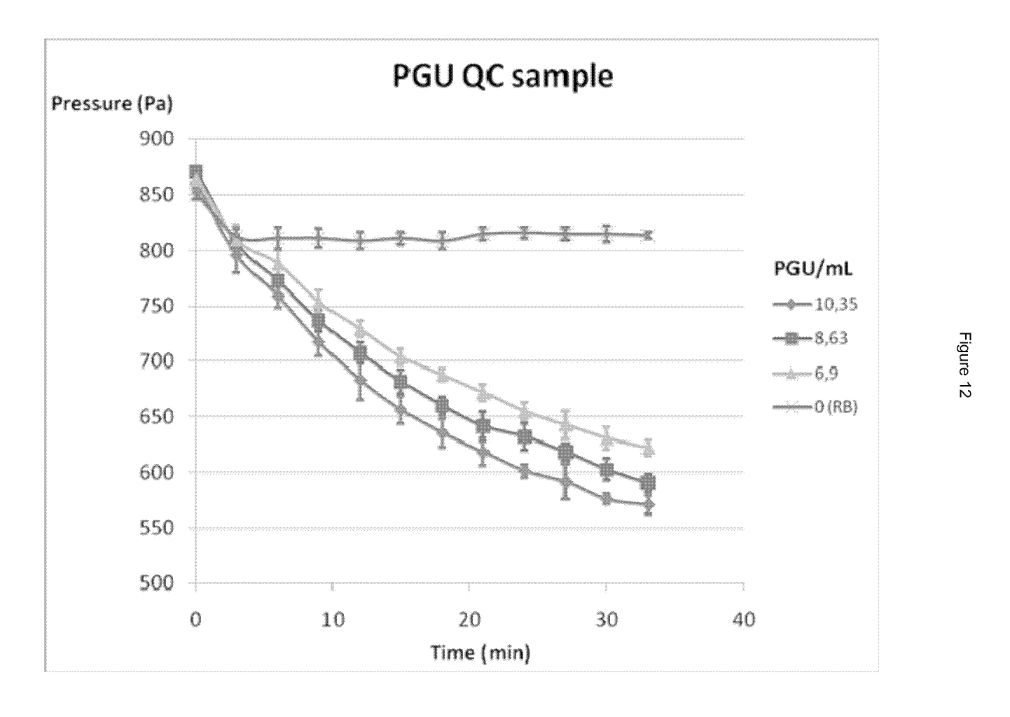

Viscosity determinations were made indirectly as pressure measurements in a pippeting device, a MICROLAB® ELISA STARlet liquidhandler (Hamilton Robotics) according to the invention. The viscosity was measured once before addition of enzyme to the reactions or water to the negative control, respectively, at time point 0 minutes. The pressure data (aspirate step) from the liquidhandler was plotted against time over about 30 minutes as shown in FIG. 12, where there is a clearly decreasing pressure difference to the atmospheric pressure, which in turn reflects decreasing viscosity in the samples over time proportionate to the pectinase activity in the samples.

### Example 6

### Measuring Xylanase Activity by Viscosity

Xylanases can by degradation of arabinoxylans alleviate the known anti-nutritional effect of these in animal feeds. When xylanase is added to feed (e.g. for monogastric animals, including poultry or swine) which contain cereals (e.g. barley, wheat, maize, rye, triticale or oats) they increase the breakdown of plant cell walls, which leads to a better release of nutrients enclosed within the plant cell. In addition, xylanase also assists in reducing viscosity caused by solubilised NSF components. The overall effect of the xylanase addition to the feed is improved growth rate and feed conversion in the animals.

The potential of the ViPr assay technology in studying enzymatic activity was investigated by the hydrolysis of the substrate Rye Arabinoxylan (Rye Flour; Megazymes) by a xylanase. The Rye Arabinoxylan substrate was prepared according to guidelines by the manufacturer but with 0.1 M NaAc buffer in stead of milli Q water as solvent.

Four different xylanases belonging to family 10 or 11 were dosed at 0.04, 0.2 and 5 mg EP/kg RAX, respectively. Enzyme stock solutions were prepared in enzyme dilution buffer: 100 mM NaAc pH 6.0, 5 mM CaCl2, 0.01% BSA, 0.01% Tween 20, Only enzyme dilution buffer was added to the negative controls.

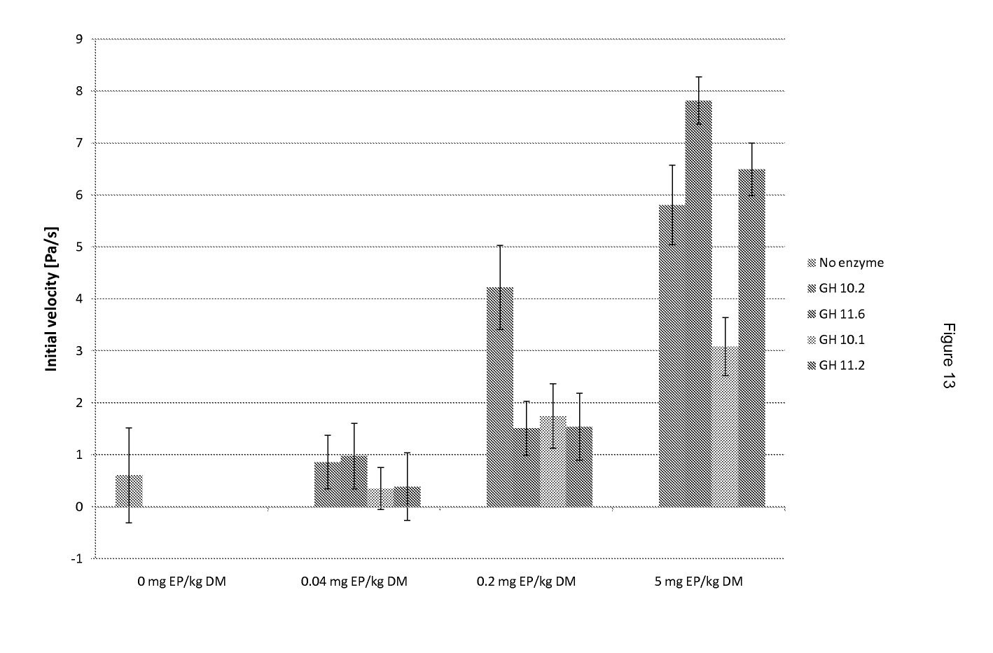

The viscosities were measured using a MICROLAB® ELISA STAR^{let} liquid handler (Hamilton Robotics) at time points 0 and 15 minutes, Custom made pipette tips were used (Ø 1.3 mm) at aspiration and dispensing speed 400 μL/s at 40° C. Measurements were conducted in triplicates and each measurement was repeated 3 times. (Pressure values were taken at time point 600 ms during dispensing). The changes in viscosities calculated from the pressure data was plotted against time in FIG. 13, which shows a clearly decreasing pressure difference to the atmospheric pressure (error bars indicate standard devations), which in turn reflects a decrease of the viscosity in the sampled liquid over time as an effect of the xylanase activity.

1. A method of determining enzyme activity in a fluid comprising at least one substrate for said enzyme activity, wherein the activity on the substrate over time provides a viscosity-change in the fluid, said method comprising:
(a) aspirating and/or dispensing at least two samples from the fluid over a suitable timespan using a device (FIG. 1) equipped with at least one pressure sensor (FIG. 1(4)) capable of measuring the changing pressure in the headspace (FIG. 1(3)) before, during and after aspiration and/or dispensation of the samples (FIG. 2), wherein the fluid is contacted with at least one enzyme prior to or after at least the first sample is aspirated and/or dispensed;
(b) correlating the obtained pressure data in (a) with the pressure data of one or more known viscosity standard aspirated and/or dispensed under comparable conditions, whereby the viscosities of the samples are determined; and
(c) calculating the enzyme activity in the fluid based on the change in the fluid viscosity in the timespan between the samples.

2. The method of claim 1, wherein the fluid is a slurry or a non-newtonian liquid.

3. The method of claim 1, wherein the substrate comprises protein, lipid, cellulose, hemicellulose, lignin, starch or a non-starch polysaccharide.

4. The method of claim 1, wherein the fluid is contacted with two or more enzymes.

5. The method of claim 1, wherein the at least one enzyme is capable of lowering the viscosity of the liquid over time.

6. The method of claim 1, wherein the at least one enzyme is capable of increasing the viscosity of the fluid over time.

7. The method of claim 1, wherein the at least one enzyme comprises an oxidoreductase, transferase, hydrolase, lyase, isomerase, or ligase;
preferably the at least one enzyme comprises an aminopeptidase, amylase, carbohydrase, carboxypeptidase, catalase, cellulase, chitinase, cutinase, cyclodextrin glycosyltransferase, deoxyribonuclease, esterase, alpha-galactosidase, beta-galactosidase, glucoamylase, alpha-glucosidase, beta-glucosidase, invertase, laccase, another lipase, mannosidase, mutanase, oxidase, pectinolytic enzyme, peroxidase, phytase, polyphenoloxidase, proteolytic enzyme, ribonuclease, transglutaminase or xylanase.

8. The method of claim 1, wherein the device is a pipette.

9. The method of claim 8, wherein the device is an automated pipette.
